(19) United States
(12) Patent Application Publication
(10) Pub. No.: US 2012/0247420 A1
(43) Pub. Date: Oct. 4, 2012

(54) ASSEMBLY WITH ADJUSTABLE COMPRESSION LOAD LIMITER

(75) Inventors: Leonard Barry Griffiths, Fenton, MI (US); Roxann M. Bittner, Bloomfield Hills, MI (US)

(73) Assignee: GM GLOBAL TECHNOLGY OPERATIONS LLC, Detroit, MI (US)

(21) Appl. No.: 13/075,258

(22) Filed: Mar. 30, 2011

(51) Int. Cl. F02B 77/00; F16B 1/00

(52) U.S. Cl. 123/198 E; 403/11

(57) ABSTRACT

An assembly includes a first component connectable to a second component by a fastener extending through respective openings in the first component and in the second component. The assembly includes a compression load limiter housed in the opening of the first component and having a passage adapted to allow the fastener to extend therethrough. The compression load limiter is adjustable due to an adjustment feature configured to cause the load limiter to translate within the opening of the first component to span a gap between the first component and the second component. The load limiter bears at least a portion of a compression load of the fastener when the fastener is inserted in the respective openings of the first and the second components to secure the first component to the second component.

### TECHNICAL FIELD

The invention relates to a compression load limiter for an assembly, such as for an engine assembly having an oil pan mounted to an engine block.

### BACKGROUND

Compression load limiters are generally used to protect components of an assembly from compressive loads generated by bolt tightening. For example, compression load limiters protect plastic from excessive tightening by a bolt used to connect the plastic component to another component. Excessive tightening of the plastic component may exceed the elastic limit of the plastic, leading to deformation, creep and eventual loosening of the assembly at the bolt.

Many assemblies, such as engine assemblies, have components with a range of build tolerances. Gaps of different sizes between the components may result from the build tolerances. This may lead to distortion of the components when bolted to one another, as the bolts may compress the components to span the gaps.

An engine assembly typically has an oil pan bolted to an engine block. The oil pan may be a composite oil pan with a steel structural brace supporting the oil pan.

### SUMMARY

An assembly includes a first component connectable to a second component by a fastener extending through respective openings in the first component and in the second component. For example, the assembly may be an engine assembly, having an oil pan as the first component, an engine block or an engine block cover as the second component, and a bolt as the fastener. The assembly includes a compression load limiter housed in the opening of the first component and having a passage adapted to allow the fastener to extend therethrough. The compression load limiter has an adjustment feature configured to cause the load limiter to translate within the opening of the first component to span a gap between the first component and the second component. The load limiter bears at least a portion of a compression load of the fastener when the fastener is inserted into the respective openings of the first and the second components to secure the first component to the second component.

The adjustment feature may be an elastomeric element secured to the inner surface of the compression load limiter in the passage, or secured to the fastener itself. Alternatively, the adjustment feature may be internal threads in the passage of the compression load limiter that mate with threads of the fastener. In these embodiments, the fastener itself drives the load limiter to span the gap. Still further, the adjustment feature could be slots at a chamfered end of the compression load limiter that allow a driving tool to adjust the load limiter to span the gap prior to insertion of the fastener.

For embodiments in which the assembly is an engine assembly, the oil pan may be a composite oil pan supported by a structural brace. The compression load limiter acts to limit the compressive load by the bolt on the oil pan while allowing the compressive load limiter to span the gap to create a solid joint between the structural brace and the engine block or engine block cover, alleviating potential bending of the oil pan.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view illustration of an engine assembly including an oil pan mounted to an engine block and an engine cover, and a structural brace supporting the oil pan;

FIG. 2 is a schematic perspective illustration of the oil pan and the structural brace of FIG. 1;

FIG. 3 is a schematic cross-sectional illustration in fragmentary view of the oil pan and structural brace of FIG. 2, taken at lines 3-3 in FIG. 2, showing bolts and a first embodiment of an adjustable bolt compression limiter;

FIG. 4 is a schematic perspective illustration of the structural brace of FIG. 1 and compression limiters supported on the oil pan, which is shown in phantom;

FIG. 5 is a schematic cross-sectional illustration in fragmentary view of the oil pan and structural brace of FIG. 3 with the bolt and the first embodiment of the adjustable bolt compression limiter in closer view;

FIG. 6 is a schematic cross-sectional illustration in fragmentary view of the oil pan and structural brace of FIG. 3 with the first embodiment of the adjustable bolt compression limiter spanning a gap between the oil pan and the engine cover;

FIG. 7 is a schematic cross-sectional illustration in fragmentary view of the oil pan and structural brace of FIG. 3 with a second embodiment of an adjustable bolt compression limiter spanning the gap between the oil pan and the engine cover; and

FIG. 8 is a schematic cross-sectional illustration in fragmentary view of the oil pan and structural brace of FIG. 3 with a third embodiment of an adjustable bolt compression limiter spanning the gap between the oil pan and the engine cover.

### DETAILED DESCRIPTION

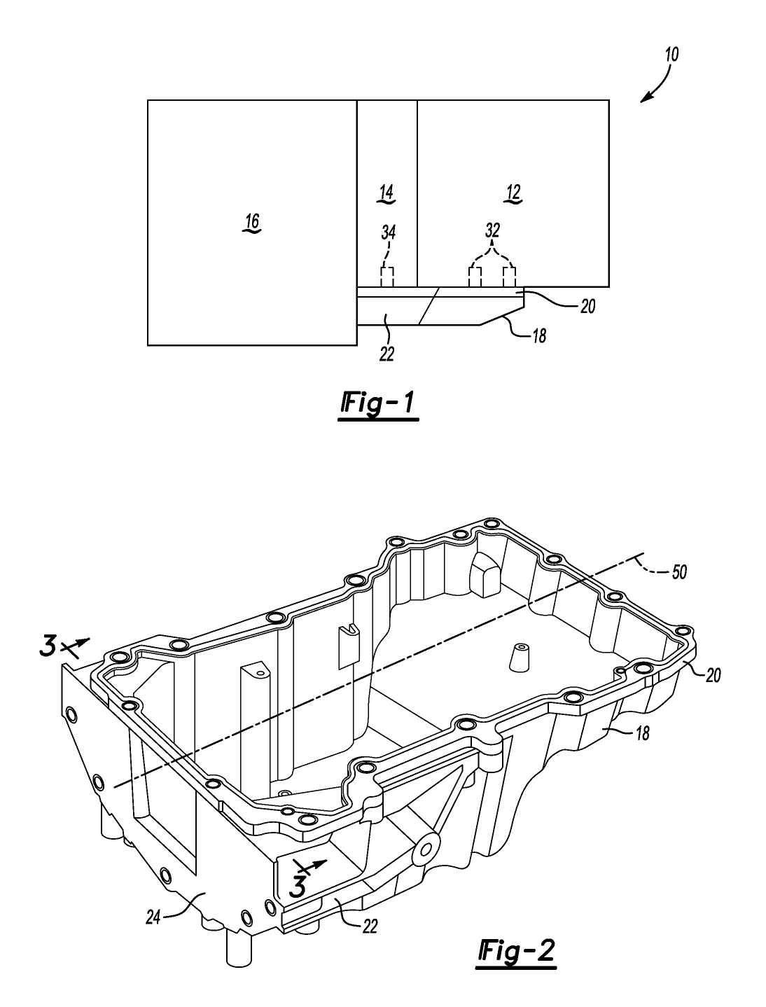

Referring to the drawings, wherein like reference numbers refer to like components, FIG. 1 shows an engine assembly 10 that includes an engine block 12 with an engine cover 14. A transmission 16 is operatively connected to the engine assembly 10. As further described below, a composite oil pan 18 is mounted to the engine block 12 and the engine cover 14 at a flange 20 of the oil pan 18, and a structural brace 22 supports the oil pan 18. The structural brace 22 protects the composite oil pan 18 and improves powertrain bending stiffness. The oil pan 18 is also referred to herein as a first component, and the engine block cover 14 as a second component.

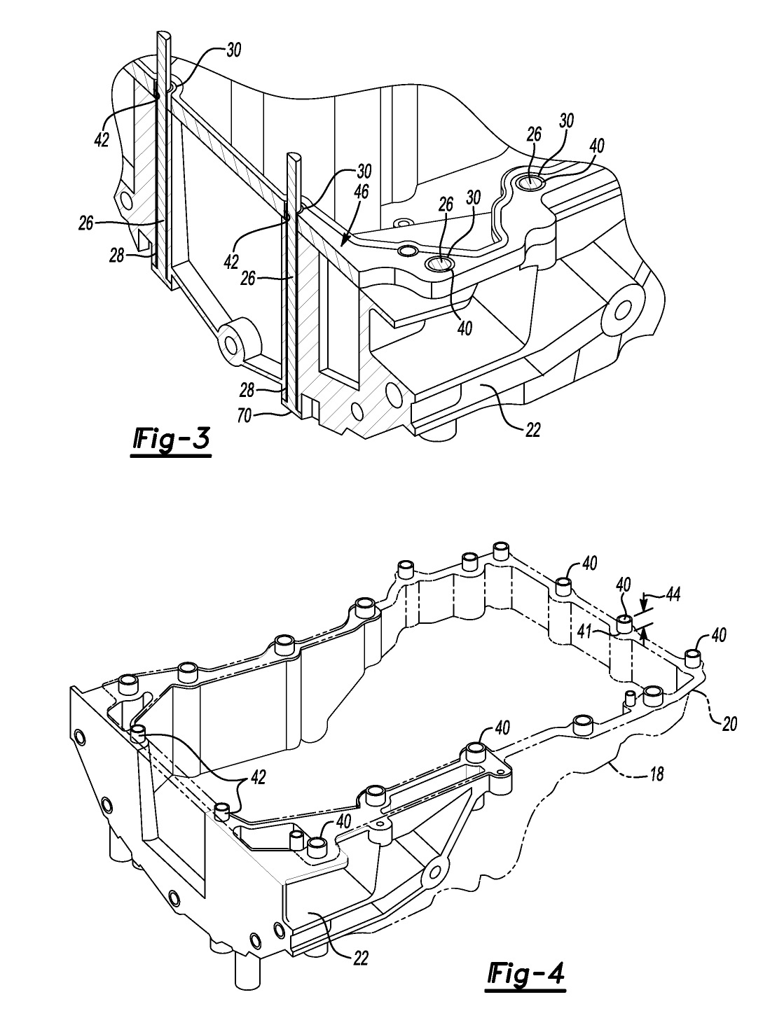

Referring to FIG. 2, the structural brace 22 surrounds a portion of the oil pan 18. A side 24 of the structural brace 22 interfaces with a housing of the transmission 16 of FIG. 1. A plurality of fasteners such as bolts 26, some of which are shown in FIG. 3, extend through openings 28 in the structural brace 22 and aligned openings 30 in the oil pan flange 20. Each bolt 26 extends through an additional opening on the engine block 12 or in the engine block cover 14, depending on where the particular bolt 26 is positioned on the oil pan flange 20. FIG. 1 shows representative openings 32 in the engine block 12 and a representative opening 34 in the engine block cover 14.

Referring to FIG. 4, the oil pan 18 is shown in phantom to better view the structural brace 22. Additionally, bolt compression limiters 40 are shown housed in the openings of the oil pan flange 20. Two adjustable bolt compression limiters 42, also referred to herein as load limiters, are positioned in the oil pan flange 20 and partially in the structural brace 22 as further described below. A person of ordinary skill in the art will readily understand the function and operation of the bolt compression limiters 40. Namely, the bolt compression limiters 40 prevent excessive compression of the composite oil pan flange 20 by bolts 26 inserted through the respective openings 30 in the oil pan flange 20 to attach the oil pan 18 to the engine block 12 or the engine block cover 14 as described with respect to FIGS. 1-3. Each bolt 26 is inserted from below the oil pan flange 20 in FIG. 1, and is threaded into either opening 32 in the engine block 12 or an opening 34 in the engine block cover 14. The head of the bolt 26 will rest against the bottom 41 of the bolt compression limiter 40, as indicated in FIG. 4, and the bolt 26 cannot compress the oil pan flange 20 to a thickness less than the thickness 44 of the bolt compression limiter 40.

Because the oil pan 18 is connected to both the engine block 12 and the engine block cover 14, as well as to the transmission 16, build tolerances of these components affect the alignment of the openings 28, 30, 32, 34, and may create gaps between the oil pan flange 20, the engine block 12, and the engine block cover 14. For example, if bolts 26 are installed to connect the oil pan 18 to the engine block 12 first (prior to the engine block cover 14), there may be a gap 45 between the upper surface 46 of the oil pan flange 20 and the lower surface 48 of the engine block cover 14, as shown in FIG. 6. If only traditional (non-adjustable) bolt compression limiters 40 are used in the oil pan flange 20, then the oil pan 18 will have to bend along its longitudinal axis 50 (indicated in FIG. 2) in order for the upper surface 46 of the oil pan flange 20 to contact the lower surface 48 of the engine block cover 14 and allow the traditional bolt compression limiter 40 to contact the engine block cover 14 to create a solid joint from the structural brace 22 to the engine block cover 14.

To avoid the potential bending and distortion of components due to build tolerances of typical bolt compression limiters, at least one adjustable bolt compression limiter 42, also referred to as an adjustable load limiter, is used to mount the oil pan 18 to the engine block 12 and the engine block cover 14. In the embodiment shown in FIG. 3, two adjustable bolt compression limiters 42 are used at the rear of the oil pan 18 and structural brace 22 in the vicinity of the transmission 16 of FIG. 1. More adjustable bolt compression limiters 42 could be used, and they may alternatively be positioned at the opposite end of the oil pan 18 where it connects to the engine block 12.

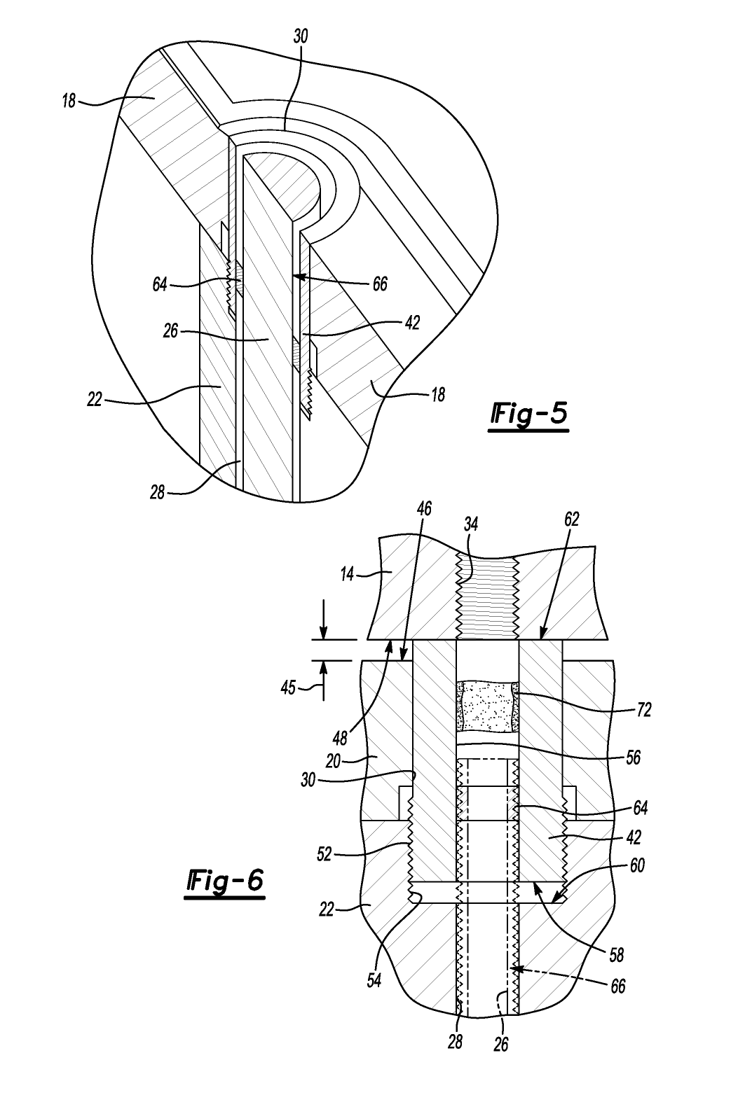

As shown in FIGS. 5 and 6, the adjustable bolt compression limiter 42 has external threads 52 at which it is initially screwed into a threaded outlet portion of the opening 28 in the structural brace 22 at internal threads 54. The adjustable bolt compression limiter 42 is generally annular with a central passage 56 through which the bolt 26 extends when connecting the structural brace 22 and oil pan flange 20 to the engine block cover 14. Prior to inserting the bolt 26, a bottom surface 58 of the bolt compression limiter 42 rests on a shoulder 60 of the opening 28. In that position, the upper surface 62 of the adjustable bolt compression limiter 42 is substantially level with the upper surface 46 of the oil pan flange 20. The adjustable bolt compression limiter 42 has an adjustment feature 64 that causes the adjustable bolt compression limiter 42 to move in unison with the bolt 26 when the bolt 26 is inserted into the passage 56 until the upper surface 62 of the adjustable bolt compression limiter 42 contacts the lower surface 48 of the engine block cover 14. The adjustable bolt compression limiter 42 thus spans the gap 45 and ensures a solid joint between the structural brace 22 and the engine block cover 14 through the adjustable bolt compression limiter 42. The bolt 26 has external threads shown in phantom.

In the embodiment of FIGS. 5 and 6, the adjustment feature 64 is an elastomeric ring attached to an inner surface of the adjustable bolt compression limiter 42 in the passage 56. The elastomeric ring adjustment feature 64 is sufficiently sized to grip the outer surface 66 of the bolt 26 as it is inserted into the passage 56. The bolt 26 acts as a drive feature to drive the adjustable bolt compression limiter 42 upward in the opening 30. The gripping of the adjustment feature 64 to the bolt 26 causes the adjustable bolt compression limiter 42 to move in unison with the bolt 26 as the bolt 26 translates through the passage 56 to thread to the engine block cover 14 at opening 34.

Alternately, the adjustment feature 64 could be an elastomeric ring identical to the ring shown in FIG. 6 but attached to the outer surface 66 of the bolt 26 and that grips the inner surface of the passage 56 when the bolt 26 is driven in the passage 56 to cause the adjustable bolt compression limiter 42 to move in unison with the bolt 26. The adjustable bolt limiter 42 moves upward in FIG. 6 with the bolt 26 until the surface 62 contacts the surface 48, closing the gap 45. The bolt 26 continues to move upward until the bolt head 70 (shown in FIG. 3) seats against the brace 22.

In other embodiments, the adjustment feature 64 could be a deformable plastic piece, a metallic spring, or another configuration able to cause the adjustable bolt compression limiter 42 to move in unison with the bolt 26.

An anti-rotation feature, such as a coating of adhesive 72 shown schematically in FIG. 6 may be applied to the inner surface of the adjustable bolt compression limiter 42 at the passage 56 to prevent rotation of the adjustable bolt compression limiter 42 relative to the bolt 26. The adhesive 72 is time curing, and would hold the relative positions of the adjustable bolt compression limiter 42 and the installed bolt 26 after curing. The adhesive 72 could be applied to the thread 52 or 54 as an anti-rotation feature between the adjustable bolt compression limiter 42 and the structural brace 22. The adjustable bolt limiter 42 prevents the bolt 26 from compressing the flange 20 or distorting or bending the flange 20 and accommodates build tolerances that create gaps, such as gap 45.

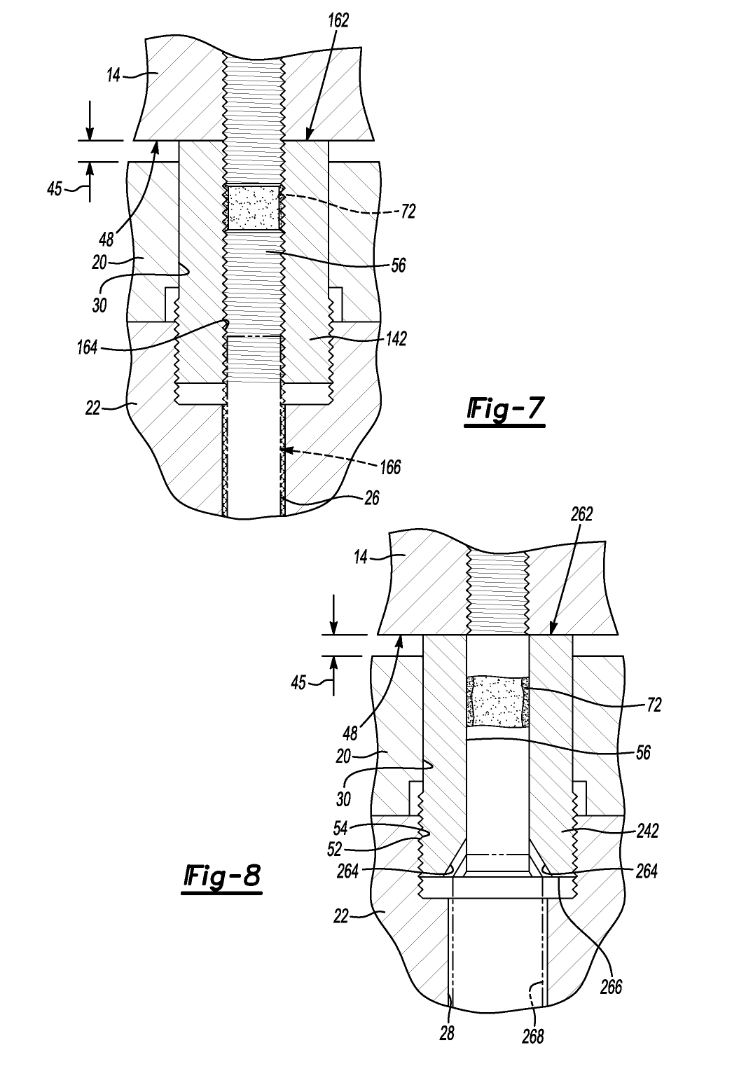

Referring to FIG. 7, an alternate embodiment of an adjustable bolt compression limiter 142 is shown. In this embodiment, the adjustable bolt compression limiter 142 has internal threads 164 at the passage 56 that act as the adjustment feature. The internal threads 164 mate with external threads 166 on the bolt 26. The mating threads 164, 166 allow the bolt 26 to act as a drive feature to drive the adjustable bolt compression limiter 142 upward in the opening 30 until the upper surface 162 of the adjustable bolt compression limiter 142 contacts the surface 48 of the engine block cover 14, with the adjustable bolt compression limiter 142 spanning the gap 45 to create a solid joint from the brace 22 to the engine block cover 14 through the adjustable bolt compression limiter 142.

Referring to FIG. 8, another alternate embodiment of an adjustable bolt compression limiter 242 is shown. In this embodiment, the adjustable bolt compression limiter 242 has slots 264 at a chamfered end 266 of the adjustable bolt compression limiter 242 that receive an end of a driving tool 268 (shown in phantom) sized to fit through the opening 28 in the brace 22. In this embodiment, the diameter of the opening 28 may be slightly larger than the diameter of the passage 56 to accommodate the slots 264 and the tool 268. The end of the tool 268 engages the adjustable bolt compression limiter 242 at the slots 264 such that the adjustable bolt compression limiter 242 turns as the tool 268 is turned, so that threads 52 move upward along threads 54 and the gap 45 is closed when the upper surface 262 contacts the surface 48 of the engine block cover 14, creating a solid joint from the brace 22 to the engine block cover 14 through the adjustable bolt compression limiter 242.

While the best modes for carrying out the invention have been described in detail, those familiar with the art to which this invention relates will recognize various alternative designs and embodiments for practicing the invention within the scope of the appended claims.

1. An assembly including a first component connectable to a second component by a fastener extending through an opening in the first component and an opening in the second component, the assembly comprising:
a compression load limiter housed in the opening of the first component and having a passage adapted to allow the fastener to extend therethrough; and
an adjustment feature configured to cause the compression load limiter to translate within the opening of the first component to span a gap between the first component and the second component, the compression load limiter thereby bearing at least a portion of a compression load of the fastener when the fastener is inserted into the respective openings of the first and the second components to secure the first component to the second component.

2. The assembly of claim 1, wherein the adjustment feature is an elastomeric element secured to the compression load limiter within the passage; and wherein the elastomeric element is configured to grip an outer surface of the fastener when the fastener is inserted in the passage to cause the compression load limiter and the fastener to move substantially in unison.

3. The assembly of claim 1, wherein the adjustment feature is an elastomeric element secured to an outer surface of the fastener; and wherein the elastomeric element is configured to grip the compression load limiter when the fastener is inserted in the passage to cause the compression load limiter and the fastener to move substantially in unison.

4. The assembly of claim 1, wherein the adjustment feature is internal threads of the compression load limiter; wherein the fastener is a bolt with external threads configured to mate with the internal threads of the compression load limiter to cause the compression load limiter to move substantially in unison with the bolt as the bolt is inserted in the compression load limiter.

5. The assembly of claim 1 in combination with a driving tool, wherein the adjustment feature is slots at an end of the compression load limiter; and wherein the slots are configured to receive the driving tool to enable the driving tool to drive the compression load limiter toward the second component within the passage to span the gap.

6. The assembly of claim 1, further comprising:
an anti-rotation feature on the compression load limiter configured to prevent rotation of the compression load limiter after the compression load limiter translates within the opening of the first component.

7. The assembly of claim 6, wherein the anti-rotation feature is a coating of adhesive between the compression load limiter and the fastener configured to prevent rotation of the compression load limiter relative to the fastener.

8. The assembly of claim 6, further comprising:
a structural brace configured to at least partially support the first component, and having another opening aligning with the opening in the first component; wherein the compression load limiter is at least partially housed within the another opening of the structural brace; and
wherein the anti-rotation feature is a coating of adhesive between the compression load limiter and the structural brace configured to prevent rotation of the compression load limiter relative to the structural brace.

9. An engine assembly comprising:
an engine block;
an engine cover mounted to the block;
a composite oil pan having a flange with openings;
wherein the engine block and the engine cover have openings configured to substantially align with the openings in the oil pan;
a structural brace configured to at least partially surround the oil pan and having at least some openings aligning with some of the openings in the flange;
a plurality of bolts each of which extends through the structural brace, the oil pan and one of the engine block and the engine cover to mount the structural brace and the oil pan to the engine block and to the engine cover; wherein the flange of the oil pan is between the structural brace and the engine cover and the engine block;
a bolt compression limiter positioned in one of the openings of the structural brace and having a passage extending therethrough; wherein one of the bolts extends through said one of the openings in the structural brace and through the passage; and
an adjustment feature configured to cause the bolt compression limiter to translate within said one of the openings of the structural brace to span a gap between the oil pan and said one of the engine cover and the engine block when said one of the bolts is inserted in the passage, the bolt compression limiter thereby bearing at least a portion of a compression load of said one of the bolts.

10. The engine assembly of claim 9, wherein the adjustment feature is an elastomeric element secured to the bolt compression limiter within the passage; and wherein the elastomeric element is configured to grip an outer surface of said one of the bolts when said one of the bolts is inserted in the passage to cause the bolt compression limiter and said one of the bolts to move substantially in unison.

11. The engine assembly of claim 9, wherein the adjustment feature is an elastomeric element secured to an outer surface of said one of the bolts; and wherein the elastomeric element is configured to grip the bolt compression limiter when said one of the bolts is inserted in the passage to cause the bolt compression limiter and said one of the bolts to move substantially in unison.

12. The engine assembly of claim 9, wherein the adjustment feature is internal threads of the passage; wherein said one of the bolts has external threads configured to mate with the internal threads to cause the bolt compression limiter to move substantially in unison with said one of the bolts as said one of the bolts is inserted in the bolt compression limiter.

13. The engine assembly of claim 9 in combination with a driving tool, wherein the adjustment feature is slots at an end of the bolt compression limiter; wherein the slots are configured to receive the driving tool to enable the driving tool to drive the bolt compression limiter toward the one of the engine block and the engine cover within the passage to span the gap.

14. The engine assembly of claim 9, further comprising:
an anti-rotation feature on the bolt compression limiter configured to prevent rotation of the bolt compression limiter after the bolt compression limiter translates within said one of the openings of the structural brace.

15. The engine assembly of claim 14, wherein the anti-rotation feature is a coating of adhesive between the bolt compression limiter and said one of the bolts configured to prevent rotation of the bolt compression limiter relative to said one of the bolts.

16. The engine assembly of claim 14, wherein the anti-rotation feature is a coating of adhesive between the bolt compression limiter and the structural brace configured to prevent rotation of the bolt compression limiter relative to the structural brace.

17. An engine assembly including an oil pan connectable to an engine block and an engine block cover by a plurality of bolts extending through respective openings in the oil pan, in the engine block, and in the engine block cover, the engine assembly comprising:
a bolt compression limiter housed in one of the openings of the oil pan and having a passage adapted to allow one of the bolts to extend therethrough; and
an adjustment feature configured to cause the bolt compression limiter to translate with said one of the bolts within said one of the openings of the oil pan to span a gap between the oil pan and one of the engine block and the engine block cover, the bolt compression limiter thereby establishing a solid joint between the oil pan and said one of engine block and the engine block cover and bearing at least a portion of a compression load of said one of the bolts.

18. The engine assembly of claim 17, wherein the oil pan has a flange; wherein said one of the openings in the oil pan is in the flange; and further comprising:
a structural brace configured to at least partially surround the oil pan and having at least one opening aligning with said one of the openings in the flange; and
wherein said one of the bolts extends through said at least one opening in the structural brace so that the oil pan flange is between the structural brace and said one of the engine block and the engine block cover.
